(19) United States
(12) Patent Application Publication
(10) Pub. No.: US 2005/0289239 A1
(43) Pub. Date: Dec. 29, 2005

(54) Method and an apparatus to classify electronic communication

(76) Inventor: Vipul Ved Prakash, San Francisco, CA (US)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 11/081,287

(22) Filed: Mar. 15, 2005

Related U.S. Application Data
(60) Provisional application No. 60/553,743, filed on Mar. 16, 2004.

(51) Int. Cl. G06F 15/173

(52) U.S. Cl. 709/238

(57) ABSTRACT

A method and an apparatus to classify electronic communications have been disclosed. In one embodiment, the method includes tokenizing a set of one or more headers in an electronic communication to generate a first set of one or more tokens and comparing the first set of tokens with a second set of one or more tokens to determine whether the electronic communication is in a predetermined category. Other embodiments have been claimed and described.

### REFERENCE TO RELATED APPLICATION

This Application claims the benefit of U.S. Provisional Patent Application No. 60/553,743, filed on Mar. 16, 2004, and entitled, “Hawthorne Lite.”

### FIELD OF INVENTION

The present invention relates to electronic communication, and more particularly, to classifying electronic communication.

### BACKGROUND

Today, the use of electronic communication has become increasingly popular for both personal purposes and work related purposes. The term “electronic communication” as used herein is to be interpreted broadly to include any type of electronic communication or message including voice mail communications, short message service (SMS) communications, multimedia messaging service (MMS) communications, facsimile communications, etc. With the increasing popularity of electronic communication, more marketers send spams to advertise their products and/or services. As used herein, the term “spam” refers to electronic communication that is not requested and/or is non-consensual. Also known as “unsolicited commercial e-mail” (UCE), “unsolicited bulk e-mail” (UBE), “gray mail” and just plain “junk mail,” spam is typically used to advertise products.

However, the mass distribution of spams causes many users not only nuisance, but costly problems as well. Therefore, many software applications have been developed to filter out spams from incoming electronic communication. Unfortunately, one typical side effect of these spam filtering software applications is that some legitimate electronic communications may be mistakenly filtered out with the spams because of false positives generated by the spam filtering software application. For example, some existing spam filtering software applications may mistakenly block a legitimate electronic newsletter because of some spam-like characteristics in the legitimate electronic newsletter, such as a large list of recipients. At best, a user may have to manually retrieve the legitimate electronic communication from a location designated for spams and/or to override the determination by the spam filtering software. At worst, the user may not even know that the legitimate electronic communication is mistakenly filtered out if the spam filtering software has caused the legitimate electronic communication to be deleted without notifying the user.

### SUMMARY

The present invention includes a method and an apparatus to classify electronic communications. In one embodiment, the method includes tokenizing a set of one or more headers in an electronic communication to generate a first set of one or more tokens and comparing the first set of tokens with a second set of one or more tokens to determine whether the electronic communication is in a predetermined category.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1A illustrates a flow diagram of one embodiment of a process to classify electronic communication;

FIG. 1B shows one exemplary electronic communication network;

FIG. 2 illustrates a flow diagram of one embodiment of a process to tokenize a header in electronic communication;

FIG. 3A shows one example of a set of Received headers in an exemplary email;

FIG. 3B shows one exemplary set of tokens generated from the Received headers shown in FIG. 3A according to one embodiment of the present invention; and

FIG. 4 illustrates one embodiment of an electronic communication system.

### DETAILED DESCRIPTION

A method and an apparatus to classify electronic communications are described. In one embodiment, the method includes tokenizing a set of one or more headers in an electronic communication to generate a first set of one or more tokens and comparing the first set of tokens with a second set of one or more tokens to determine whether the electronic communication is in a predetermined category.

In the following description, numerous specific details are set forth. However, it is understood that embodiments of the invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

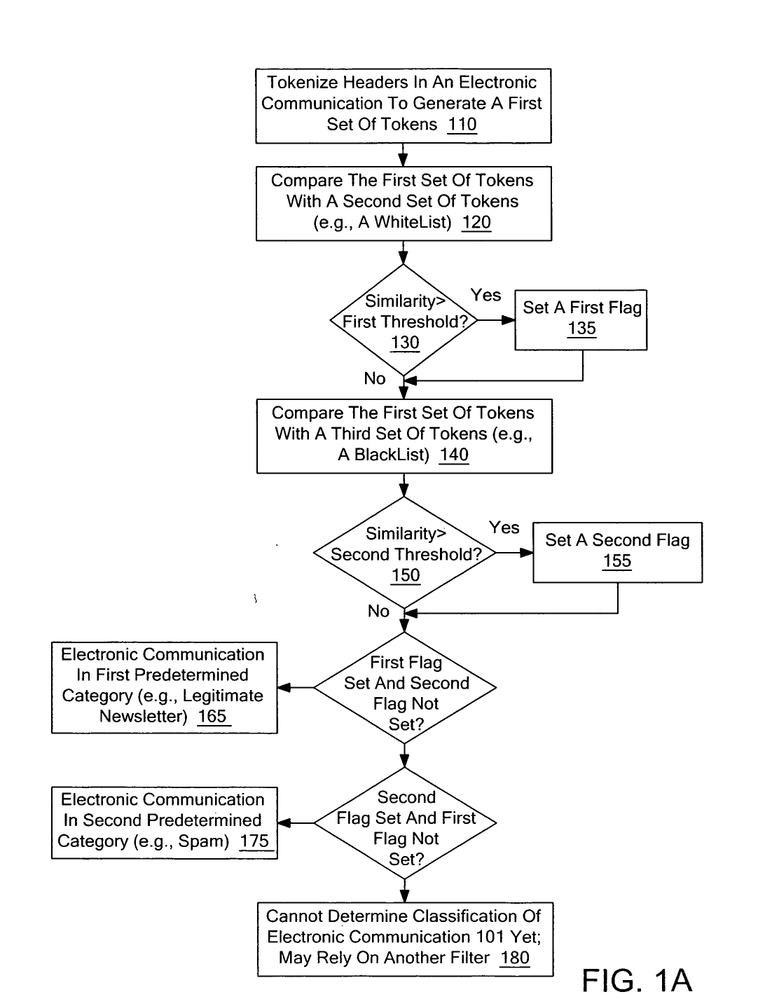

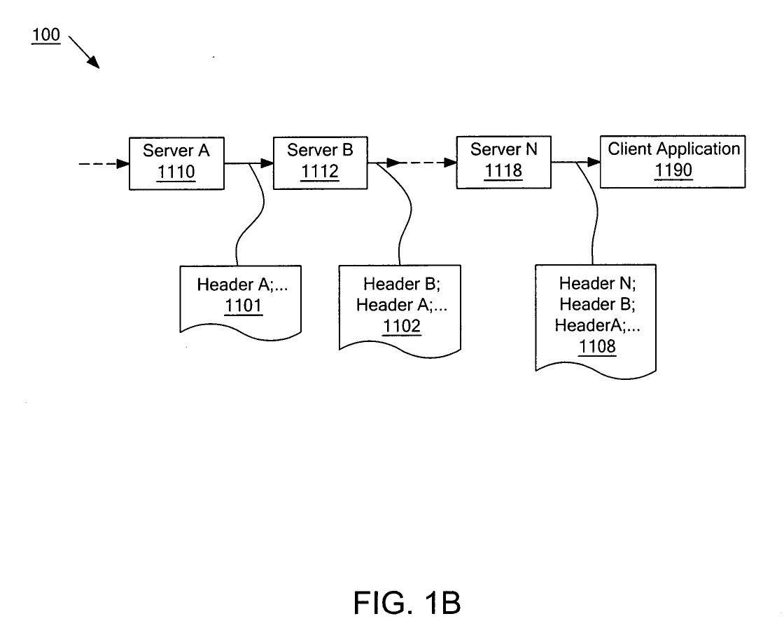

FIG. 1A shows a flow diagram of one embodiment of a process for classifying electronic communication. The process is performed by processing logic that may comprise hardware (e.g., circuitry, dedicated logic, etc.), software (such as is run on a general-purpose computer system or a dedicated machine), or a combination of both.

Processing logic tokenizes a set of one or more headers in an electronic communication received at an electronic communication client application (e.g., an email software) to generate a first set of one or more tokens (processing block 110). The electronic communication may contain various types of headers that are hard to forge. For email communications the headers that are hard to forge are received headers. As a result, the following discussion will focus on the Received headers. However, it should be appreciated that the technique disclosed herein is applicable to other types of headers as appropriate.

During tokenization, processing logic may extract some predetermined information from the headers. However, in one embodiment, if a certain value is missing in one of the headers, processing logic may ignore this header and generate no token from this header. Processing logic may generate as many tokens as the relevant information is available in the headers by going through every Received header in the electronic communication.

In addition to information within an individual header, processing logic may extract the order of a header within the set of headers in the electronic communication and encode the order extracted into the tokens. With respect to Received headers the order of the headers is useful in determining the route the electronic communication has taken to reach the client application. FIG. 1B shows an exemplary embodiment of an electronic communication network to illustrate this concept.

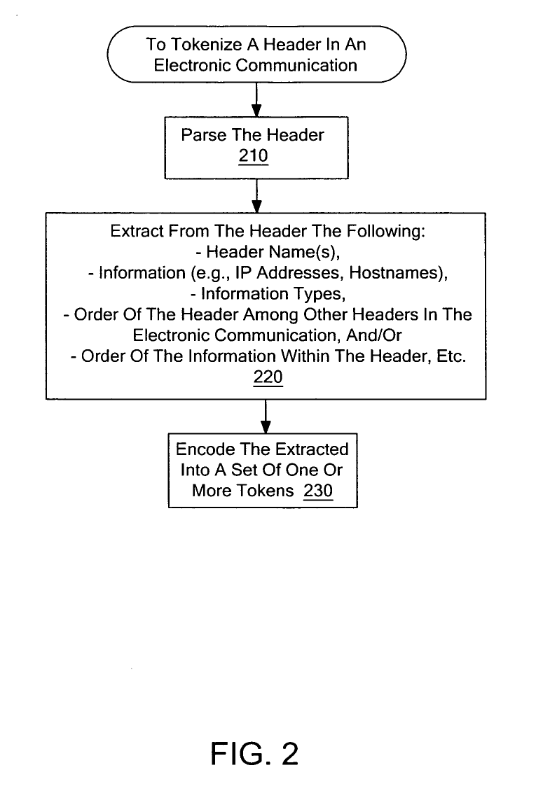

Referring to FIG. 1B, the electronic communication network 100 includes a number of servers (e.g., server A 1110, server B 1112, server N 1118) and a client application 1190. The electronic communications 1101, 1102, 1108 are routed via the servers to the client application 1190. When one electronic communication is routed through a server, the server adds a Received header that includes various information of the server (e.g., hostname, IP address, etc.) into the electronic communication. For instance, server A 1110 adds Header A into the electronic communication 1101, server B 1112 adds Header B to the electronic communication 1102, and server N×18 adds Header N to the electronic communication 1108. Note that the order of the headers (e.g., Header A, Header B, Header N) in the electronic communication 1108 corresponds to the order in which the electronic communication 1108 has passed through the servers. Therefore, the client application 1190 may determine the route the electronic communication 1108 has taken to reach the client application 1190 using the order of the headers in the electronic communication ×08. Hence, processing logic encodes the order of the headers in the tokens generated from the headers. More detail on the tokenization of a header is discussed below with reference to FIG. 2.

Referring back to FIG. 1A, processing logic may compare the first set of tokens with a second set of tokens (processing block 120). In one embodiment, the second set of tokens is generated from another known electronic communication in the first predetermined category. In one embodiment, the first predetermined category includes legitimate electronic communications, and hence, the second set is referred to as a “White List.” For example, the first predetermined category may include legitimate electronic newsletters that the user of the client application wants to receive and the second set of tokens is generated from a set of one or more headers in one of these legitimate electronic newsletters.

Processing logic then determines whether the similarity between the first and the second sets of tokens exceeds a first predetermined threshold, such as 95% (processing block 130). If the similarity exceeds the first predetermined threshold, then processing logic sets a first flag (processing block 135). Otherwise, the first flag is left unset. Various approaches may be used to determine the similarity between two sets of tokens. For example, one may use the following quantitative metric, sim, for similarity between two sets of tokens, A and B:
sim=|intersect(A,B)|/sqrt(|A|)*sqrt(|B|), where |x| means the size of the set x.

According to the above equation, the quantitative metric for similarity can be thought of as a dot product of the two sets of tokens (i.e., set A and set B) divided by the product of the magnitude of the two sets. Furthermore, tf−idf weighting may be used in the determination of the similarity between two sets of tokens in order to de-emphasize commonly occurring features and emphasize relatively rare features in the two sets of tokens.

As discussed above, the tokens may include the order of the headers, which may correspond to the route the electronic communication has taken. Therefore, if the first set of tokens is substantially similar to the tokens of a known legitimate electronic communication, the electronic communication received is likely to have been routed through many of the servers used by the known legitimate electronic communication in a substantially similar order. Hence, the electronic communication 1101 is likely to be legitimate as well. However, to prevent a spammer from defeating the mechanism by forging the headers in a spam, processing logic may also compare the first set of tokens with a third set of tokens (processing block 140). Order encoding also prevents attacks from spammers who could insert fake headers crafted to provide legitimacy to the email. Spammers have no control over the order in which their headers will appear, and they can not force the same order present in legitimate communications.

In one embodiment, the third set of tokens is generated from another known electronic communication in a second predetermined category. The second predetermined category may include electronic communications to be filtered out, such as spams. Hence, the third set of tokens may also be referred to as a “Black List.” Processing logic may determine whether the similarity between the first set of tokens and the third set of tokens exceeds a second predetermined threshold (processing block 150). In one embodiment, the second predetermined threshold is approximately at or above 95%. However, one should appreciate that the first and second predetermined thresholds may or may not be the same. If the similarity exceeds the second predetermined threshold, then processing logic may set a second flag (processing block 155). Furthermore, one should appreciate that the order in which processing logic compares the first set of tokens with the White List or the Black List may be switched in some embodiments.

Based on the results of comparing the first set of tokens with the White List or the Black List, processing logic may then classify the electronic communication. If the first flag is set but not the second flag, then processing logic may classify the electronic communication to be in the first predetermined category (processing block 165). For example, the second set of tokens are generated from a known legitimate newsletter and the third set of tokens are generated from a known spam. Setting the first flag indicates that the tokens of the electronic communication is substantially similar to the tokens of the legitimate newsletter. Thus, the electronic communication is likely to have been routed through many of the servers used by the legitimate newsletter in a substantially similar order.

Referring back to FIG. 1A, if the second flag is set but not the first flag, then processing logic may classify the electronic communication to be in the second predetermined category (processing block 175). However, if both the first and the second flags are set or both flags are not set, then processing logic cannot decide whether the electronic communication is in the first or the second predetermined category based on the comparisons of the tokens. Therefore, processing logic may rely on an electronic communication filtering mechanism to classify the electronic communication (processing block 180). In one embodiment, processing logic may rely on classification provided by a community of users reporting electronic communications of a certain category, such as SpamNet provided by Cloudmark, Inc. in San Francisco, Calif.

FIG. 2 illustrates a flow diagram of one embodiment of a process to tokenize a header (e.g., a Received header) in an electronic communication. The process is performed by processing logic that may comprise hardware (e.g., circuitry, dedicated logic, etc.), software (such as is run on a general-purpose computer system or a dedicated machine), or a combination of both.

Referring to FIG. 2, processing logic parses the header (processing block 210). Then processing logic extracts from the parsed header some predetermined information, such as hostnames and Internet Protocol (IP) addresses from a Received header (processing block 220).

In addition to extracting the information, processing logic may extract from the header one or more header names, one or more information types, the order of the information within the header, and the order of the header among a set of headers in the electronic communication (processing block 220). The order of the header among a set of headers in the electronic communication is useful for determining the route the electronic communication has traveled as explained above. In one embodiment, processing logic classifies an electronic communication received based on how similar the route the electronic communication has traveled is to the route of one or more known electronic communication (e.g., spams, legitimate electronic newsletter, etc.).

Then processing logic encodes the extracted information, the header names, information types, the order of the information within the header, and the order of the header among the set of headers into a set of one or more tokens (processing block 230). In one embodiment, the structure of a token is in the form of [header_name]-[information_type]-[information].

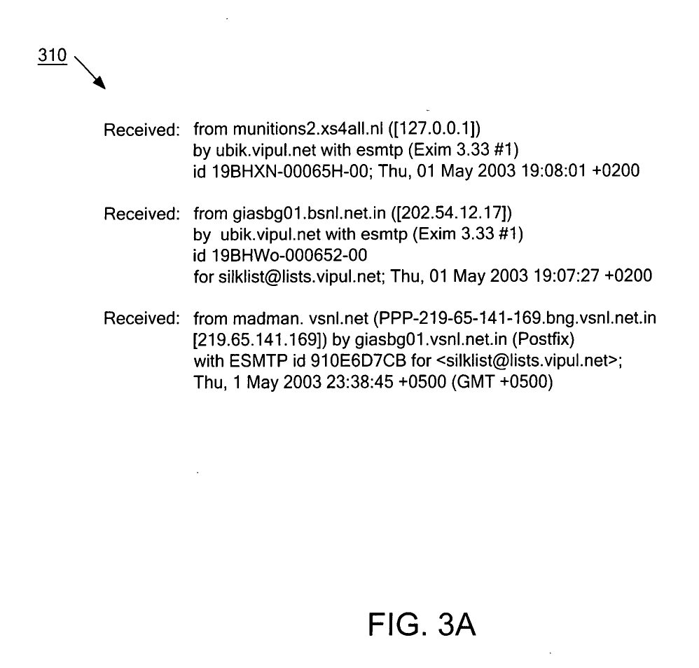

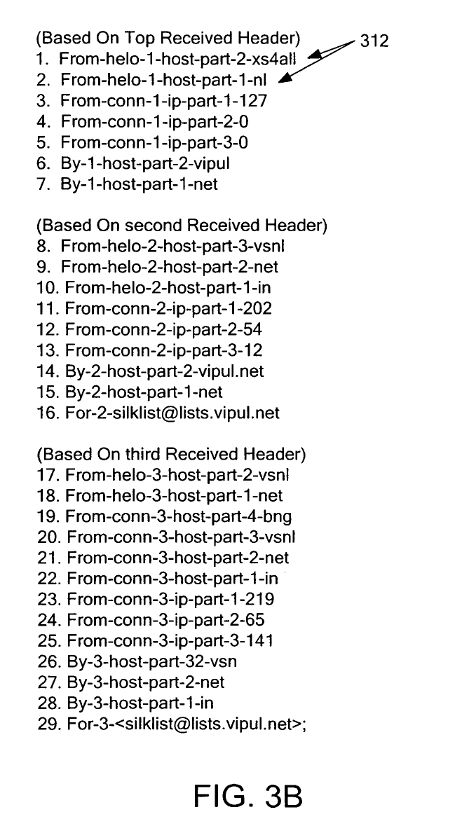

Some predetermined information in the header may be encoded in multiple tokens. In one embodiment, the hostnames and IP addresses in a Received header may be broken into multiple tokens to allow identification of partially matching hostnames and/or IP addresses. FIG. 3A shows one example of a set of Received headers in an representative email. FIG. 3B shows a sample set of tokens generated from the Received headers in FIG. 3A according to one embodiment of the present invention. Referring to FIG. 3A, the hostname 310 of the first Received header is broken into the multiple tokens 312 in FIG. 3B.

In some embodiments, a predetermined portion of some information in the header may be dropped such that no token is generated from the dropped portion. For example, the hostname portion of the hosts and/or the lowest octet of the IP addresses in a Received header may be dropped to remove some potential sources of noise from the Received header. Referring back to FIGS. 3A and 3B, the hostname portion of the hosts in the Received headers may be dropped (e.g., “munitions2” in the first Received header in FIG. 3A) to remove a potential source of noise from the headers. Likewise, the lowest octet of an IP address (e.g., “1” in the first Received header in FIG. 3A) may also be dropped.

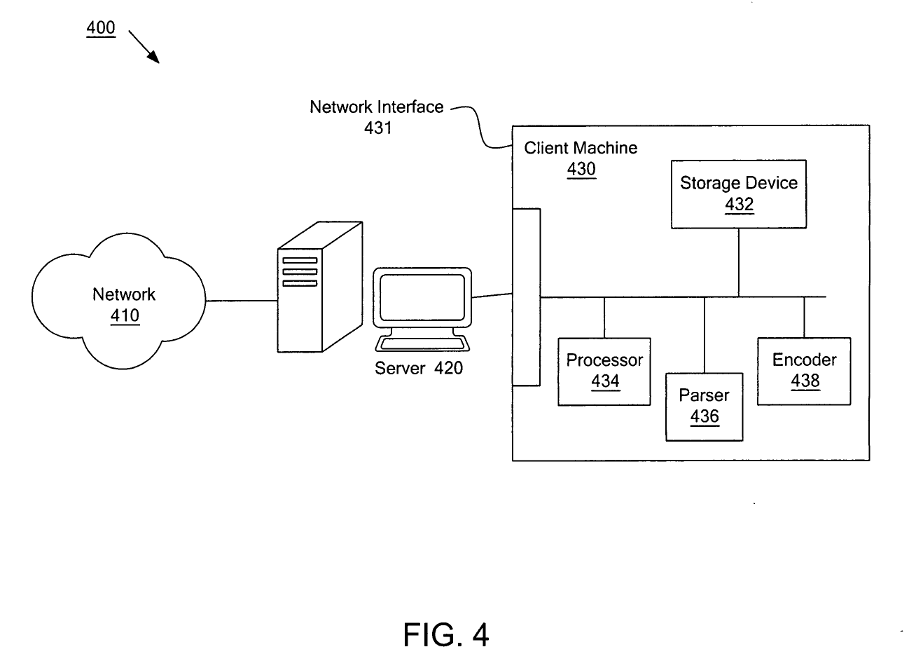

FIG. 4 illustrates one embodiment of an electronic communication system usable with the present invention. The system 400 includes a network 410, an electronic communication server 420, and a client machine 430. The network 410 may include additional electronic communication servers to route electronic communication. The electronic communication server 420 is coupled to the client machine 430. The client machine 430 may include a personal computer.

In one embodiment, the client machine 430 includes a storage device 432, a processor 434, a parser 436, and an encoder 438. Note that the components within the client machine 430 may be implemented by hardware (e.g., a dedicated circuit), software (such as is run on a general-purpose machine), or a combination of both. The network interface 431 is operable to receive electronic communication from the server 420. The parser 436 may parse a set of one or more headers in the electronic communication received to extract some predetermined types of information. The encoder 438 may encode the extracted information to generate a set of tokens for the electronic communication received. The storage device 432 may store one or more sets of predetermined tokens. The processor 436 is operable to compare the stored tokens with the tokens generated from the headers in the electronic communication received. Based on the comparison, the processor 436 may classify the electronic communication received to be in a predetermined category. Some embodiments of the process to classify the electronic communication and the process to tokenize a header have been discussed above.

Note that any or all of the components and the associated hardware illustrated in FIG. 4 may be used in various embodiments of the networked system 400. In one embodiment, the networked system 400 may be a distributed system. Some or all of the components in the networked system 400 (e.g., the electronic communication server 420) may be local or remote. However, it should be appreciated that other configuration of the networked system may include one or more additional devices not shown in FIG. 4.

One advantage of classifying an electronic communication based on tokens generated from the headers in the electronic communication is to avoid mistakenly classifying legitimate electronic newsletter or electronic communications having a relatively large mailing list as spams.

Some portions of the preceding detailed description have been presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will appear from the description below. In addition, the present invention is not described with reference to any particular programming language. It will be appreciated that a variety of programming languages may be used to implement the teachings of the invention as described herein.

A machine-accessible medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

The foregoing discussion merely describes some exemplary embodiments of the present invention. One skilled in the art will readily recognize from such discussion, the accompanying drawings and the claims that various modifications can be made without departing from the spirit and scope of the invention.

1. A method comprising:
tokenizing a set of routing information contained in or associated with an electronic communication to generate a first set of one or more tokens; and
classifying the electronic communication into a predetermined category by comparing the first set of one or more tokens with a second set of one or more tokens that represent the predetermined category.

2. The method of claim 1, further comprising:
comparing the first set of one or more tokens to multiple sets of one or more tokens, each representing a predetermined category for classifying the electronic communication.

3. The method of claim 1, further comprising:
classifying the first electronic communication in the predetermined category represented by the second set of one or more tokens if similarity between the first and the second sets of one or more tokens exceeds a predetermined threshold.

4. The method of claim 1, wherein the routing information is a set of one or more RFC822 email headers.

5. The method of claim 4, wherein the set of one or more headers includes one or more Received headers.

6. The method of claim 1, wherein the routing information includes one or more hostnames and one or more Internet Protocol (IP) addresses of one or more servers the electronic communication has been routed through.

7. The method of claim 1, wherein tokenizing the routing information comprises:
parsing the set of routing information; and
extracting from each of the set of routing information one or more routing information header names, data contained in routing information headers, one or more data types, order of the data within the corresponding routing information header, and order of the corresponding routing information header within the set of one or more headers.

8. The method of claim 7, wherein tokenizing the set of routing information further comprises encoding the extracted routing information that contains one or more routing information header names, data contained in routing information headers, one or more data types, order of the data within the corresponding routing information header, and order of the corresponding routing information.

9. A machine-accessible medium that provides instructions that, if executed by a processor, will cause the processor to perform operations comprising:
tokenizing a set of routing information contained in or associated with an electronic communication to generate a first set of one or more tokens; and
classifying the electronic communication into a predetermined category by comparing the first set of one or more tokens with a second set of one or more tokens that represent the predetermined category.

10. The machine-accessible medium of claim 9, wherein the operations further comprise:
comparing the first set of one or more tokens to multiple sets of one or more tokens, each representing a predetermined category for classifying the electronic communication.

11. The machine-accessible medium of claim 9, wherein the operations further comprise:
classifying the first electronic communication in the predetermined category represented by the second set of one or more tokens if similarity between the first and the second sets of one or more tokens exceeds a predetermined threshold.

12. The machine-accessible medium of claim 9, wherein tokenizing the set of one or more headers comprises:
parsing the set of routing information; and
extracting from each of the set of routing information one or more routing information header names, data contained in routing information headers, one or more data types, order of the data within the corresponding routing information header, and order of the corresponding routing information header within the set of one or more headers.

13. The machine-accessible medium of claim 12, wherein tokenizing the set of one or more headers further comprises:
encoding the extracted routing information that contains one or more routing information header names, data contained in routing information headers, one or more data types, order of the data within the corresponding routing information header, and order of the corresponding routing information.

14. The machine-accessible medium of claim 12, wherein the set of one or more headers includes one or more Received headers.

15. The machine-accessible medium of claim 14, wherein the information includes one or more hostnames and one or more Internet Protocol (IP) addresses of one or more servers the electronic communication has been routed through.

16. A system comprising:
A means for tokenizing a set of routing information contained in or associated with an electronic communication to generate a first set of one or more tokens; and
A means for classifying the electronic communication into a predetermined category by comparing the first set of one or more tokens with a second set of one or more tokens that represent the predetermined category.

17. The system of claim 16, wherein the client machine further comprises a means for parsing the set of routing information; and
A means for extracting from each of the set of routing information one or more routing information header names, data contained in routing information headers, one or more data types, order of the data within the corresponding routing information header, and order of the corresponding routing information header within the set of one or more headers.

18. The system of claim 17, wherein the client machine further comprises a means for encoding the extracted routing information that contains one or more routing information header names, data contained in routing information headers, one or more data types, order of the data within the corresponding routing information header, and order of the corresponding routing information.

19. The system of claim 18, further comprising a means for classifying the first electronic communication in the predetermined category represented by the second set of one or more tokens if similarity between the first and the second sets of one or more tokens exceeds a predetermined threshold.
